(19) United States
(12) Patent Application Publication
(10) Pub. No.: US 2025/0033085 A1
(43) Pub. Date: Jan. 30, 2025

(54) ULTRASONIC WAVE GENERATION DEVICE AND ULTRASONIC WAVE GENERATION SYSTEM

(71) Applicant: NITERRA CO., LTD., Nagoya-shi, Aichi (JP)

(72) Inventors: Shinsuke ITOH, Nagoya-shi, Aichi (JP); Kota YOKOYAMA, Nagoya-shi, Aichi (JP); Satoshi SUZUKI, Nagoya-shi, Aichi (JP); Ryo SUZUKI, Nagoya-shi, Aichi (JP); Takashi KASASHIMA, Nagoya-shi, Aichi (JP)

(73) Assignee: NITERRA CO., LTD., Nagoya-shi, Aichi (JP)

(21) Appl. No.: 18/716,352

(22) PCT Filed: Nov. 21, 2022
(86) PCT No.: PCT/JP2022/042994

§ 371 Date: Jun. 4, 2024

(30) Foreign Application Priority Data
Jan. 5, 2022 (JP) 2022-000370

(51) Int. Cl. B06B 3/00

(52) U.S. Cl. CPC B06B 3/00

(57) ABSTRACT

An ultrasonic wave converging part (12) and a waveguide (13) have a through-hole (20) penetrating the converging part and the waveguide in a front-rear direction. An inner circumferential surface (20A) forming the through-hole has inner circumferential surface (21) and deformed portion (23) located on a front-end side relative to the inner circumferential surface. The inner circumferential surface has, as a cross-sectional shape in the front-rear direction, a shape linearly extending in the front-rear direction. The deformed portion is, in a cross section in the front-rear direction, at least one of a portion located inward of the inner circumferential surface and a portion located outward of the inner circumferential surface (FIG. 1 showing the portion located inward of the first inner circumferential surface), and is formed in a part of or over an entire circumference (FIG. 1 showing the entire circumference) of the inner circumferential surface in a circumferential direction.

### TECHNICAL FIELD

The present invention relates to an ultrasonic wave generation device and an ultrasonic wave generation system.

### BACKGROUND ART

Non-Patent Document 1 discloses a technology in which a plane wave generated through vibrations of a piezoelectric ceramic is converged by an ultrasonic wave converging part, and the resultant wave is propagated to a waveguide having a small diameter and is outputted from the front end of the waveguide (see FIG. 2 (a) of “2. Proposed Structure” in p. 7). In addition, Non-Patent Document 1 discloses a configuration in which a through-hole penetrating the ultrasonic wave converging part and the waveguide is formed in the ultrasonic wave converging part and the waveguide (see FIGS. 2 (b) and (c) of “2. Proposed Structure” in p. 7). The through-hole is assumed to be used for, for example, the following purposes. That is, the through-hole may be used for applying an ultrasonic wave to a liquid flowing through the through-hole, may be used for performing sensing near the front end of the waveguide by passing a sensor therethrough, may be used as a passage for suctioning a tissue fractured by an ultrasonic wave outputted from the front end of the waveguide, or may be used for other purposes.

### PRIOR ART DOCUMENT

### Non-Patent Document

Non-Patent Document 1: Kyohei Yamada, Kang Chen, Takasuke Irie, Takashi Iijima, Susumu Miyake, and Takeshi Morita, “Fundamental Study of Tube-Type Double-Parabolic-Reflectors Ultrasonic Transducer”, IEICE Technical Report US2021-9 (2021-06)

### SUMMARY OF THE INVENTION

### Problem to be Solved by the Invention

In the technology of Non-Patent Document 1, the shape of the through-hole has not been sufficiently developed, and there is room for improvement in this respect.

An object of the present invention is to provide a technology capable of applying a novel action to an object in a through-hole by improving the shape of a through-hole penetrating an ultrasonic wave converging part and a waveguide.

### Means for Solving the Problem

[1] An ultrasonic wave generation device in the present invention includes: an ultrasonic wave generation source configured to generate an ultrasonic wave; an ultrasonic wave converging part configured to converge the ultrasonic wave generated from the ultrasonic wave generation source; and a waveguide configured to allow transmission therethrough of the ultrasonic wave converged by the ultrasonic wave converging part. In the ultrasonic wave generation device, the ultrasonic wave generation source, the ultrasonic wave converging part, and the waveguide are arranged in this order from a rear-end side. The ultrasonic wave converging part and the waveguide have a through-hole penetrating the ultrasonic wave converging part and the waveguide in a front-rear direction. An inner circumferential surface forming the through-hole has a first inner circumferential surface and a deformed portion located on a front-end side relative to the first inner circumferential surface. The first inner circumferential surface has, as a cross-sectional shape taken in the front-rear direction, a shape linearly extending in the front-rear direction. The deformed portion is, in a cross section taken in the front-rear direction, at least one of a portion located inward of the first inner circumferential surface and a portion located outward of the first inner circumferential surface. The deformed portion is formed in a part of or over an entire circumference of the inner circumferential surface in a circumferential direction.

According to the above ultrasonic wave generation device, a novel action can be applied to an object in the through-hole by the deformed portion provided on the inner circumferential surface forming the through-hole.

[2] In the ultrasonic wave generation device according to [1], the through-hole may serve as a flow path through which a liquid flows.

When an ultrasonic wave transmitted through at least one of the ultrasonic wave converging part and the waveguide is applied via the inner circumferential surface to a liquid flowing inside the through-hole, the ultrasonic wave is likely to become uneven in terms of the reach thereof so as to be concentrated on the liquid near the inner circumferential surface forming the through-hole. In this respect, in the above ultrasonic wave generation device, the flow of the liquid in the through-hole is turned into a turbulent flow by the deformed portion, and thus it becomes easy for the ultrasonic wave, which advances to the inside via the inner circumferential surface forming the through-hole, to reach the entire liquid.

[3] In the ultrasonic wave generation device according to [2], the inner circumferential surface may further have a second inner circumferential surface located on the front-end side relative to the deformed portion, and the second inner circumferential surface may have, as a cross-sectional shape taken in the front-rear direction, a shape linearly extending in the front-rear direction.

According to the above ultrasonic wave generation device, a liquid that has flowed into the through-hole from the rear-end side and that has been caused to have a turbulent flow by the deformed portion can be made into a laminar flow or a flow similar to the laminar flow by the second inner circumferential surface.

[4] In the ultrasonic wave generation device according to [2] or [3], the deformed portion may be provided in a portion, of the through-hole, that penetrates the waveguide.

According to the above ultrasonic wave generation device, an ultrasonic wave having a rather small amplitude can be applied to the liquid flowing through the portion, of the through-hole, that penetrates the waveguide.

[5] In the ultrasonic wave generation device according to any one of [2] to [4], the deformed portion may be provided in a portion, of the through-hole, that penetrates the ultrasonic wave converging part.

According to the above ultrasonic wave generation device, an ultrasonic wave having a rather large amplitude can be applied to the liquid flowing through the portion, of the through-hole, that penetrates the ultrasonic wave converging part.

### Advantageous Effects of the Invention

According to the present invention, a novel action can be applied to an object in the through-hole by improving the shape of the through-hole penetrating the ultrasonic wave converging part and the waveguide.

### BRIEF DESCRIPTION OF THE DRAWINGS

FIG. 1 is a cross-sectional view of an ultrasonic wave generation device in a first embodiment.

FIG. 2 is a cross-sectional view at a line X-X in FIG. 1.

FIG. 3 is a diagram for explaining a state where a liquid is supplied into a through-hole.

FIG. 4 is a diagram showing a configuration of an ultrasonic wave generation system.

FIG. 5 is a cross-sectional view of an ultrasonic wave generation device in a second embodiment.

FIG. 6 is a cross-sectional view of an ultrasonic wave generation device in a third embodiment.

FIG. 7 is a cross-sectional view at a line Y-Y in FIG. 6.

FIG. 8 is a cross-sectional view of an ultrasonic wave generation device in a fourth embodiment.

FIG. 9 is a cross-sectional view of an ultrasonic wave generation device in a fifth embodiment.

FIG. 10 is a diagram, corresponding to FIG. 2, of an embodiment in which a deformed portion having a protruding shape is provided only in a part of an inner circumferential surface in a circumferential direction.

FIG. 11 is a diagram, corresponding to FIG. 7, of an embodiment in which a deformed portion having a recessed shape is provided only in a part of the inner circumferential surface in the circumferential direction.

FIG. 12 is a diagram, corresponding to FIG. 2, of an embodiment in which a deformed portion having an elliptical shape is provided.

FIG. 13 is a diagram, corresponding to FIG. 2, of an embodiment in which a deformed portion having the shape of a cross is provided.

FIG. 14 is a diagram, corresponding to FIG. 2, of an embodiment in which a deformed portion having the shape of a star is provided.

FIG. 15 is a diagram, corresponding to FIG. 2, of an embodiment in which a deformed portion having a central axis shifted from a central axis of a first inner circumferential surface is provided.

FIG. 16 is a cross-sectional view of an ultrasonic wave generation device provided with a plurality of deformed portions.

FIG. 17 is a cross-sectional view of an ultrasonic wave generation device provided with a second reflection surface having a form different from that in the first embodiment.

### MODES FOR CARRYING OUT THE INVENTION

### 1. First Embodiment

### 1-1. Configuration of Ultrasonic Wave Generation Device 10

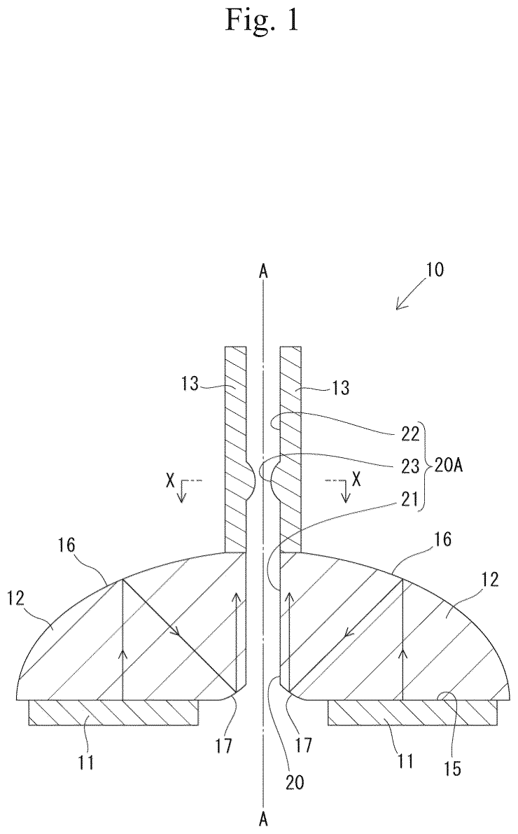

As shown in FIG. 1, the ultrasonic wave generation device 10 includes an ultrasonic wave generation source 11, an ultrasonic wave converging part 12, and a waveguide 13. The ultrasonic wave generation source 11 generates an ultrasonic wave. The ultrasonic wave converging part 12 converges the ultrasonic wave generated from the ultrasonic wave generation source 11. The waveguide 13 allows transmission therethrough of the ultrasonic wave converged by the ultrasonic wave converging part 12. The ultrasonic wave generation device 10 is formed by arranging the ultrasonic wave generation source 11, the ultrasonic wave converging part 12, and the waveguide 13 in this order from a rear-end side.

The ultrasonic wave generation source 11 is, for example, a piezoelectric element formed of piezoelectric ceramic. The ultrasonic wave generation source 11 has the shape of a plate having a thickness in a front-rear direction. The ultrasonic wave generation source 11 has an annular shape (more specifically, a round-ring shape).

The ultrasonic wave generation source 11 generates an ultrasonic wave when receiving an electric signal from a power supply device 100 described later. The ultrasonic wave generation source 11 has a radiation surface 15 from which an ultrasonic wave is generated. The radiation surface 15 is provided on a front-end side of the ultrasonic wave generation source 11 and provided in a state of facing frontward. The radiation surface 15 is a flat surface and spreads in a direction orthogonal to the front-rear direction of the ultrasonic wave generation device 10. As shown in FIG. 1, the ultrasonic wave generated from the ultrasonic wave generation source 11 is a plane wave that advances straight frontward. The ultrasonic wave generation source 11 generates an ultrasonic wave having a frequency of, for example, 30 kHz or higher and 3 MHz or lower.

The ultrasonic wave converging part 12 is formed of a metal (for example, duralumin). The ultrasonic wave converging part 12 has a rear end portion joined to the radiation surface 15 of the ultrasonic wave generation source 11. The ultrasonic wave converging part 12 has a first reflection surface 16 and a second reflection surface 17. The first reflection surface 16 is located to be opposed to the radiation surface 15 of the ultrasonic wave generation source 11. A direction in which the first reflection surface 16 and the radiation surface 15 of the ultrasonic wave generation source 11 are opposed to each other is parallel to the front-rear direction. The first reflection surface 16 is a curved surface (for example, a paraboloid) protruding to a front side (a side opposite to the ultrasonic wave generation source 11) as seen from outside of the ultrasonic wave converging part 12. The first reflection surface 16 has a recessed shape as seen from inside of the ultrasonic wave converging part 12. A center portion of the first reflection surface 16 is located frontward of an outer circumferential edge of the first reflection surface 16. The first reflection surface 16 is a paraboloid of revolution about an axis A. The axis A is an axial line that passes through the center of the ultrasonic wave generation source 11 and that extends in the front-rear direction. The ultrasonic wave converging part 12 has an annular shape about the axis A.

The second reflection surface 17 is located to be opposed to the first reflection surface 16. The second reflection surface 17 is a curved surface (for example, a paraboloid) protruding to a rear side (a side opposite to the first reflection surface 16) as seen from outside of the ultrasonic wave converging part 12. The second reflection surface 17 has a recessed shape as seen from inside of the ultrasonic wave converging part 12. A center portion of the second reflection surface 17 is located frontward of an outer circumferential edge of the second reflection surface 17. The second reflection surface 17 has the shape of a curved surface expanding rearward.

The waveguide 13 has a tubular shape extending frontward from the front end of the ultrasonic wave converging part 12. Although the waveguide 13 in the present embodiment is described as a member separate from the ultrasonic wave converging part 12, the waveguide 13 may be the same member as the ultrasonic wave converging part 12. The waveguide 13 is preferably formed of a material having high ultrasonic-wave-propagation properties. For example, the waveguide 13 is preferably formed of an aluminum alloy, metal glass, or the like. Alternatively, the waveguide 13 may be formed of, for example, a shape memory alloy that is an alloy composed of titanium and nickel. The waveguide 13 can be elastically deformed.

The ultrasonic wave converging part 12 and the waveguide 13 have a through-hole 20 penetrating the ultrasonic wave converging part 12 and the waveguide 13 in the front-rear direction. The through-hole 20 is formed of: an internal space of the ultrasonic wave converging part 12 having an annular shape; and an internal space of the waveguide 13 having the tubular shape. The rear end of an inner circumferential surface 20A forming the through-hole 20 is contiguous with the front end of the above second reflection surface 17.

The ultrasonic wave generation source 11 is disposed so as not to close the through-hole 20. The ultrasonic wave generation source 11 is disposed outward, in a radial direction orthogonal to the front-rear direction (hereinafter, also referred to simply as “radial direction”), of the outer circumferential edge of the second reflection surface 17. The ultrasonic wave generation source 11 has an annular shape (more specifically, a round-ring shape) enclosing the outer circumferential edge of the second reflection surface 17. The through-hole 20 is opened toward the rear side of the ultrasonic wave generation source 11 through the internal space of the ultrasonic wave generation source 11.

The inner circumferential surface 20A forming the through-hole 20 has a first inner circumferential surface 21, a second inner circumferential surface 22, and a deformed portion 23.

The first inner circumferential surface 21 is located frontward of the second reflection surface 17. The rear end of the first inner circumferential surface 21 is contiguous with the front end of the second reflection surface 17. The first inner circumferential surface 21 has, as a cross-sectional shape taken in the front-rear direction, a shape linearly extending in the front-rear direction. The first inner circumferential surface 21 has a shape obtained by linearly elongating the shape of a predetermined first cross section in the front-rear direction. The first cross section is a cross section, of the first inner circumferential surface 21, that is taken in the direction orthogonal to the front-rear direction. The shape and the size of the first cross section of the first inner circumferential surface 21 are constant in the front-rear direction. The shape of the first cross section of the first inner circumferential surface 21 is a circular shape.

The second inner circumferential surface 22 is located frontward of the first inner circumferential surface 21. The second inner circumferential surface 22 is a front end portion of the inner circumferential surface 20A. The second inner circumferential surface 22 has, as a cross-sectional shape taken in the front-rear direction, a shape linearly extending in the front-rear direction. The second inner circumferential surface 22 has a shape obtained by linearly elongating the shape of a predetermined second cross section in the front-rear direction. The second cross section is a cross section, of the second inner circumferential surface 22, that is taken in the direction orthogonal to the front-rear direction. The shape and the size of the second cross section of the second inner circumferential surface 22 are constant in the front-rear direction. The shape of the second cross section of the second inner circumferential surface 22 is a circular shape. The shape and the size of the second cross section of the second inner circumferential surface 22 are the same as the shape and the size of the first cross section of the first inner circumferential surface 21. That is, the second cross-sectional shape is the same as the first cross-sectional shape.

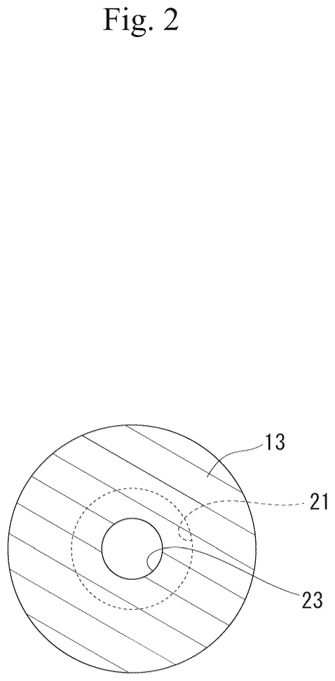

The deformed portion 23 is, in the front-rear direction, provided between the first inner circumferential surface 21 and the second inner circumferential surface 22 and contiguous with the first inner circumferential surface 21 and the second inner circumferential surface 22. As shown in FIG. 1 and FIG. 2, the deformed portion 23 is, in a cross section taken in the front-rear direction, a portion located inward of the first inner circumferential surface 21. The deformed portion 23 has a shape protruding radially inward of the first inner circumferential surface 21 and the second inner circumferential surface 22. The deformed portion 23 is curved such that a center portion thereof in the front-rear direction protrudes radially inward. The deformed portion 23 is formed over the entire circumference of the inner circumferential surface 20A in the circumferential direction. The shape of a cross section, of the deformed portion 23, that is taken in the direction orthogonal to the front-rear direction is a circular shape.

### 1-2. Configuration of Ultrasonic Wave Generation System

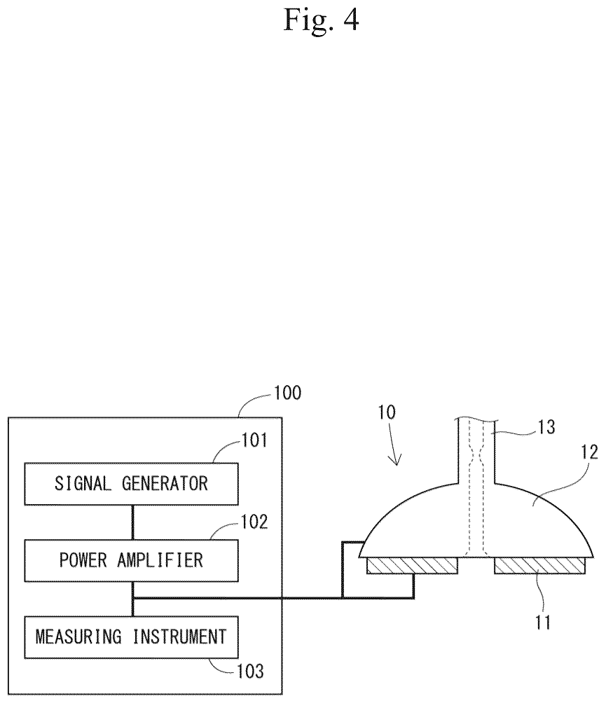

As shown in FIG. 4, an ultrasonic wave generation system includes the ultrasonic wave generation device 10 and the power supply device 100. The power supply device 100 outputs an electric signal to an electrode of the ultrasonic wave generation device 10 to drive the ultrasonic wave generation device 10.

The power supply device 100 includes a signal generator 101, a power amplifier 102, and a measuring instrument 103. The signal generator 101 generates an arbitrarily-set vibration signal. As the signal generator 101, for example, a frequency response analyzer may be used. The power amplifier 102 amplifies the signal outputted from the signal generator 101 and applies the amplified signal to the ultrasonic wave generation device 10. As the power amplifier 102, for example, a known power amplifier may be used. The measuring instrument 103 monitors the signal amplified by the power amplifier 102. As the measuring instrument 103, for example, an oscilloscope may be used. The power supply device 100 supplies the amplified signal to the ultrasonic wave generation device 10 and monitors applied voltage.

In the present embodiment, the ultrasonic wave converging part 12 is formed of a metal and has electrical conductivity, and thus the power supply device 100 is connected to the ultrasonic wave converging part 12 and electrically connected to the ultrasonic wave generation source 11 via the ultrasonic wave converging part 12. If the ultrasonic wave converging part 12 is an insulating material, the power supply device 100 and the ultrasonic wave generation source 11 may be connected to each other directly or via another electrically-conductive member.

### 1-3. Actions and Effects of Ultrasonic Wave Generation Device 10

When receiving an electric signal from the power supply device 100, the ultrasonic wave generation source 11 generates an ultrasonic wave from the radiation surface 15 toward the front side. The ultrasonic wave radiated from the radiation surface 15 is reflected by the first reflection surface 16 and converged to a focus for the first reflection surface 16. The focus for the first reflection surface 16 is the same as a focus for the second reflection surface 17. Thus, the ultrasonic wave having passed through the focus for the first reflection surface 16 is reflected by the second reflection surface 17 and introduced into the waveguide 13 as a plane wave. The ultrasonic wave introduced into the waveguide 13 is transmitted through the inside of the waveguide 13 and outputted from the front end of the waveguide 13.

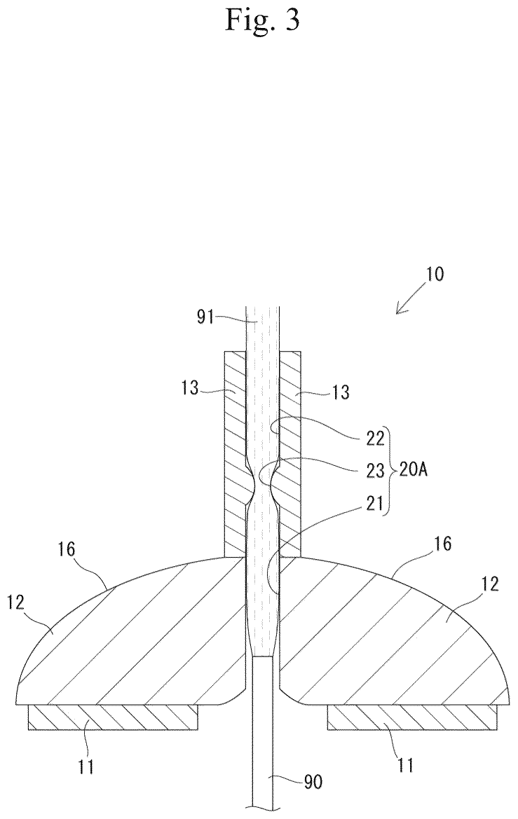

The through-hole 20 penetrating the ultrasonic wave converging part 12 and the waveguide 13 serves as a flow path through which a liquid 91 flows, as shown in FIG. 3. In the through-hole 20, the liquid 91 supplied from the rear side by a liquid supply part 90 is caused to flow frontward. The liquid 91 flowing inside the through-hole 20 comes into contact with the inner circumferential surface 20A forming the through-hole 20, thereby receiving the ultrasonic wave transmitted through the ultrasonic wave converging part 12 and the waveguide 13. An action obtained by applying the ultrasonic wave to the liquid 91 is, for example, generation of microbubbles inside the liquid 91, or the like.

In an internal region of the first inner circumferential surface 21, the flow of the liquid 91 is likely to become a laminar flow. Thus, the ultrasonic wave easily reaches the radially outer side, of the liquid 91, that is close to the first inner circumferential surface 21, but the ultrasonic wave does not easily reach the radially inner side, of the liquid 91, that is away from the first inner circumferential surface 21. In this respect, in the ultrasonic wave generation device 10, the deformed portion 23 is provided frontward of the first inner circumferential surface 21, and thus, when the liquid 91 flows from the first inner circumferential surface 21 to the deformed portion 23, the flow of the liquid 91 tends to turn into a turbulent flow. Accordingly, the radially inner side and the radially outer side of the liquid 91 are exchanged, which makes it easy for the ultrasonic wave to reach the entire liquid 91. In particular, the ultrasonic wave generation device 10 has a configuration in which a flow path on the inner side of the deformed portion 23 is narrower than a flow path on the inner side of the first inner circumferential surface 21, and thus, from this viewpoint as well, the ultrasonic wave easily reaches the entire liquid 91.

In addition, the deformed portion 23 is provided in a portion, of the through-hole 20, that penetrates the waveguide 13. The ultrasonic wave transmitted through the ultrasonic wave converging part 12 and the waveguide 13 is attenuated toward the front side. Therefore, an ultrasonic wave having a rather small amplitude can be applied to the liquid 91 flowing on the inner side of the deformed portion 23.

In addition, the second inner circumferential surface 22 is provided frontward of the deformed portion 23. Therefore, the flow, of the liquid 91, that has been turned into the turbulent flow by the deformed portion 23 is returned to a laminar flow or a flow similar to the laminar flow by the second inner circumferential surface 22. Then, the liquid 91, the flow of which has been returned to a laminar flow or a flow similar to the laminar flow, is ejected from the front end of the ultrasonic wave generation device 10.

### 2. Second Embodiment

Although the ultrasonic wave generation device in the first embodiment has a configuration in which the deformed portion is provided in the portion, of the through-hole, that penetrates the waveguide, the present invention is not limited to this configuration. In a second embodiment, an example in which the deformed portion is provided in a portion, of the through-hole, that penetrates the ultrasonic wave converging part will be described. In descriptions of the second embodiment, the same components as those in the first embodiment are denoted by the same reference characters, and detailed descriptions thereof are omitted.

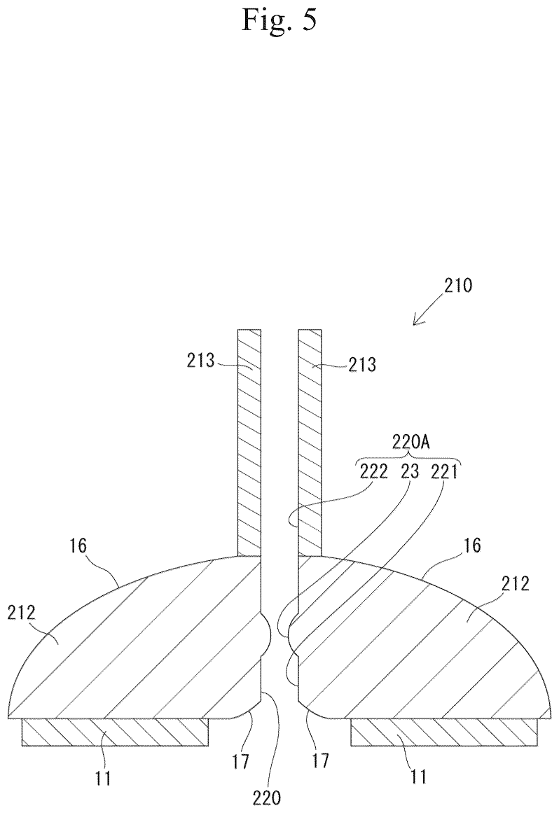

An ultrasonic wave generation device 210 in the second embodiment includes the ultrasonic wave generation source 11, an ultrasonic wave converging part 212, and a waveguide 213 as shown in FIG. 5. The ultrasonic wave converging part 212 and the waveguide 213 have a through-hole 220 penetrating the ultrasonic wave converging part 212 and the waveguide 213 in the front-rear direction. An inner circumferential surface 220A forming the through-hole 220 has a first inner circumferential surface 221, a second inner circumferential surface 222, and the deformed portion 23.

The ultrasonic wave converging part 212 differs from the ultrasonic wave converging part 12 in the first embodiment in that the ultrasonic wave converging part 212 is provided with the deformed portion 23, and other features thereof are the same. The waveguide 213 differs from the waveguide 13 in the first embodiment in that the waveguide 213 is not provided with the deformed portion 23, but is the same in other features. The first inner circumferential surface 221 differs from the first inner circumferential surface 21 in the first embodiment in that the length in the front-rear direction of the first inner circumferential surface 221 is small, and other features thereof are the same. The second inner circumferential surface 222 differs from the second inner circumferential surface 22 in the first embodiment in that the length in the front-rear direction of the second inner circumferential surface 222 is large, and other features thereof are the same.

The deformed portion 23 is provided in a portion, of the through-hole 220, that penetrates the ultrasonic wave converging part 212. Therefore, in the ultrasonic wave generation device 210 in the second embodiment, an ultrasonic wave having a rather large amplitude can be applied to the liquid 91 flowing on the inner side of the deformed portion 23.

### 3. Third Embodiment

The shape of the deformed portion is not limited to that of the first embodiment. In a third embodiment, another example of the deformed portion will be described. In descriptions of the third embodiment, the same components as those in the first embodiment are denoted by the same reference characters, and detailed descriptions thereof are omitted.

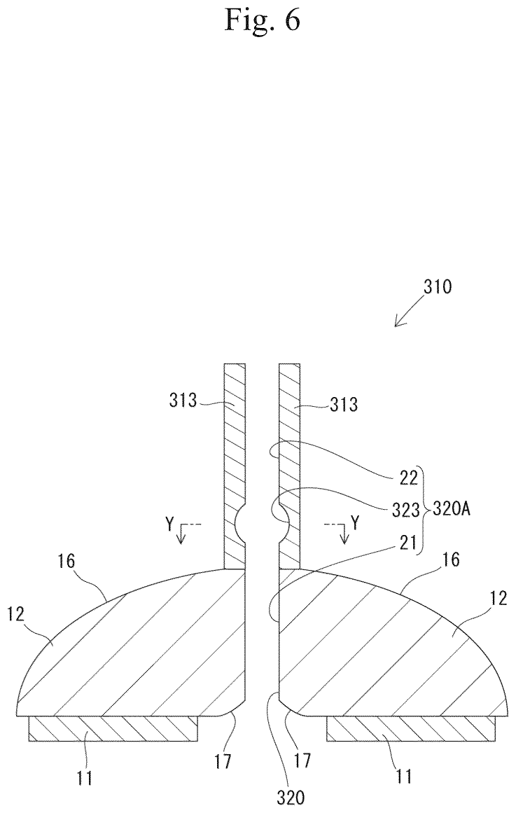

An ultrasonic wave generation device 310 in the third embodiment includes the ultrasonic wave generation source 11, the ultrasonic wave converging part 12, and a waveguide 313 as shown in FIG. 6. The ultrasonic wave converging part 12 and the waveguide 313 have a through-hole 320 penetrating the ultrasonic wave converging part 12 and the waveguide 313 in the front-rear direction. An inner circumferential surface 320A forming the through-hole 320 has the first inner circumferential surface 21, the second inner circumferential surface 22, and a deformed portion 323.

The waveguide 313 differs from the waveguide 13 in the first embodiment in that the waveguide 313 is provided with the deformed portion 323 instead of the deformed portion 23 in the first embodiment, and other features thereof are the same.

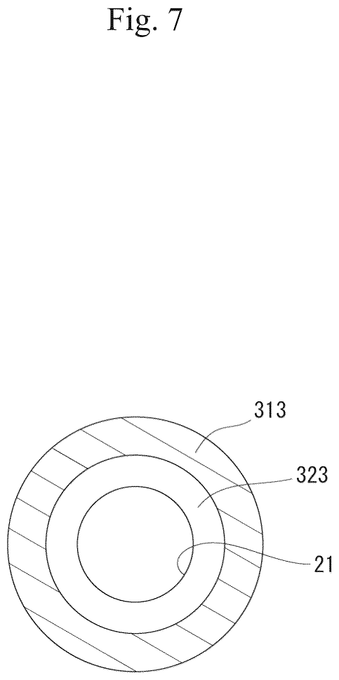

As shown in FIG. 6 and FIG. 7, the deformed portion 323 is, in a cross section taken in the front-rear direction, a portion located outward of the first inner circumferential surface 21. The deformed portion 323 is configured as a recess formed in the inner circumferential surface 320A. The deformed portion 323 has a shape recessed radially outward of the first inner circumferential surface 21 and the second inner circumferential surface 22. The deformed portion 323 is curved such that a center portion thereof in the front-rear direction is recessed to a large extent. The deformed portion 323 is formed over the entire circumference of the inner circumferential surface 320A in the circumferential direction.

In the ultrasonic wave generation device 310 in the third embodiment, a turbulent flow can be caused in the flow of the liquid 91 flowing through the through-hole 320 by the deformed portion 323.

### 4. Fourth Embodiment

In a fourth embodiment, a third example of the shape of the deformed portion will be described. In descriptions of the fourth embodiment, the same components as those in the first embodiment are denoted by the same reference characters, and detailed descriptions thereof are omitted.

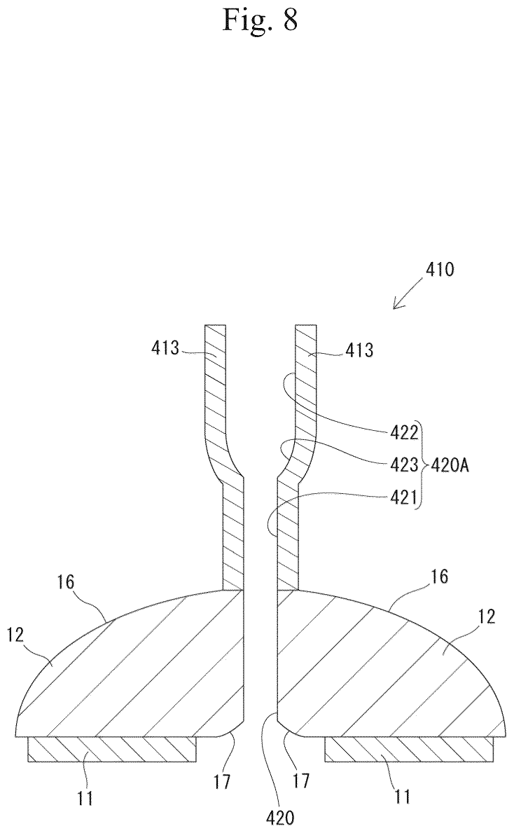

An ultrasonic wave generation device 410 in the fourth embodiment includes the ultrasonic wave generation source 11, the ultrasonic wave converging part 12, and a waveguide 413 as shown in FIG. 8. The ultrasonic wave converging part 12 and the waveguide 413 have a through-hole 420 penetrating the ultrasonic wave converging part 12 and the waveguide 413 in the front-rear direction. An inner circumferential surface 420A forming the through-hole 420 has a first inner circumferential surface 421, a second inner circumferential surface 422, and a deformed portion 423.

The first inner circumferential surface 421 is located frontward of the second reflection surface 17. The rear end of the first inner circumferential surface 421 is contiguous with the front end of the second reflection surface 17. The first inner circumferential surface 421 has, as a cross-sectional shape taken in the front-rear direction, a shape linearly extending in the front-rear direction. The first inner circumferential surface 421 has a shape obtained by linearly elongating the shape of a predetermined first cross section in the front-rear direction. The shape and the size of the first cross section of the first inner circumferential surface 421 are constant in the front-rear direction. The shape of the first cross section of the first inner circumferential surface 421 is a circular shape.

The second inner circumferential surface 422 is located frontward of the first inner circumferential surface 421. The second inner circumferential surface 422 is a front end portion of the inner circumferential surface 420A. The second inner circumferential surface 422 has, as a cross-sectional shape taken in the front-rear direction, a shape linearly extending in the front-rear direction. The second inner circumferential surface 422 has a shape obtained by linearly elongating the shape of a predetermined second cross section in the front-rear direction. The shape and the size of the second cross section of the second inner circumferential surface 422 are constant in the front-rear direction. The shape of the second cross section of the second inner circumferential surface 422 is a circular shape. The size of the second cross section of the second inner circumferential surface 422 is larger than the size of the first cross section of the first inner circumferential surface 421. That is, in the present embodiment, the second cross-sectional shape is larger than the first cross-sectional shape.

The deformed portion 423 is, in the front-rear direction, provided between the first inner circumferential surface 421 and the second inner circumferential surface 422 and contiguous with the first inner circumferential surface 421 and the second inner circumferential surface 422. The deformed portion 423 has the shape of a curved surface having a diameter that increases toward the front side. Therefore, in the ultrasonic wave generation device 410 in the fourth embodiment, a turbulent flow can be caused in the flow of the liquid 91 flowing through the through-hole 420 by the deformed portion 423, and then, the flow can be returned to a laminar flow or made into a flow similar to the laminar flow by the second inner circumferential surface 422. As a result, it becomes easy for the ultrasonic wave, transmitted through the waveguide 413, to reach the entire liquid 91 flowing through the through-hole 420.

### 5. Fifth Embodiment

In each of the first to fourth embodiments, the manner of using the through-hole as a flow path through which a liquid flows has been described. However, another manner of use may be employed. In a fifth embodiment, an example of the other manner of use will be described by using the ultrasonic wave generation device described in the second embodiment.

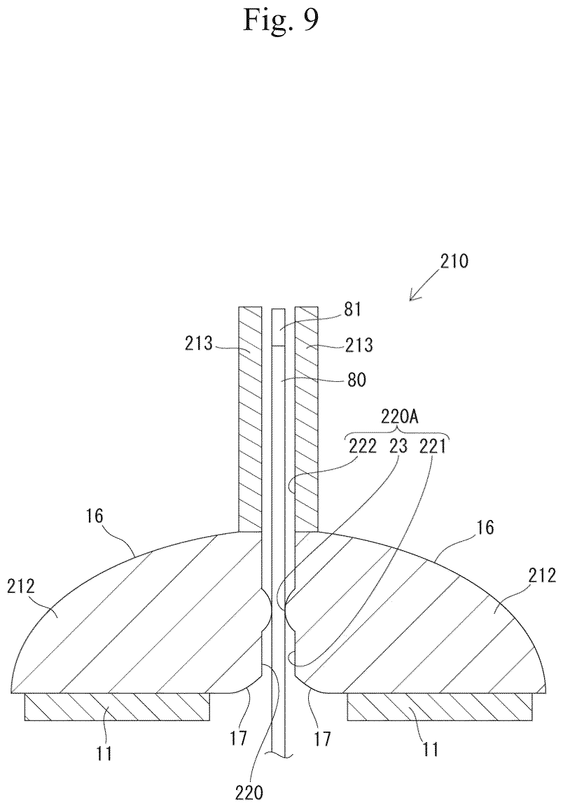

As shown in FIG. 9, a sensor probe 80 is inserted from the rear side into the through-hole 220 of the ultrasonic wave generation device 210. A sensor 81 is fixed to a front end portion of the sensor probe 80. The sensor 81 receives, for example, an ultrasonic wave outputted from the waveguide 213 and reflected by an object (not shown).

If the sensor probe 80 comes into contact with the inner circumferential surface 220A forming the through-hole 220, the ultrasonic wave might leak to the sensor probe 80 side from the contact portion. In this respect, in the ultrasonic wave generation device 210 shown in FIG. 9, the inner circumferential surface 220A is provided with the deformed portion 23 protruding inward. This can minimize a portion where the sensor probe 80 comes into contact with the inner circumferential surface 220A. As a result, the ultrasonic wave can be inhibited from leaking through the sensor probe 80. In addition, if the sensor probe 80 comes into contact with the second reflection surface 17, an ultrasonic wave reflected by the first reflection surface 16 might leak through the sensor probe 80 without being reflected by the second reflection surface 17. However, as shown in FIG. 9, the deformed portion 23 is provided on the ultrasonic wave converging part 212 side closer to the second reflection surface 17 in the ultrasonic wave converging part 212 and the waveguide 213. With this configuration, the sensor probe 80 can be more assuredly prevented from coming into contact with the second reflection surface 17. It is preferable that the sensor probe 80 is not easily bent.

### Other Embodiments

Embodiments of the present invention are not limited to those described in the above explanations and with reference to the drawings, and, for example, the following embodiments are also included in the technical scope of the present invention. In addition, various features in the above embodiments and embodiments described later may be combined in any way as long as the combination does not lead to any contradiction.

(1) In the above first embodiment, the deformed portion 23 having a protruding shape is integrated with the tubular body serving as the waveguide 13. However, the deformed portion 23 may be a separate member. In each of the above second embodiment and the fifth embodiment, the deformed portion 23 having a protruding shape is integrated with the member serving as the ultrasonic wave converging part 12, 212. However, the deformed portion 23 may be a separate member.

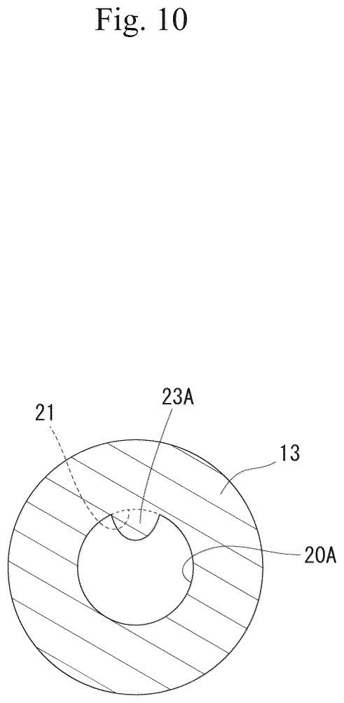

(2) In the above first embodiment, the deformed portion 23 having a protruding shape is formed over the entire circumference of the inner circumferential surface 20A forming the through-hole 20 in the circumferential direction. However, the deformed portion may be formed only in a part of the inner circumferential surface 20A in the circumferential direction as a deformed portion 23A shown in FIG. 10. That is, as shown in FIG. 10, the deformed portion 23A may have a form protruding radially inward from a part of the inner circumferential surface 20A in the circumferential direction. The same applies to the deformed portion 23 in the above second embodiment.

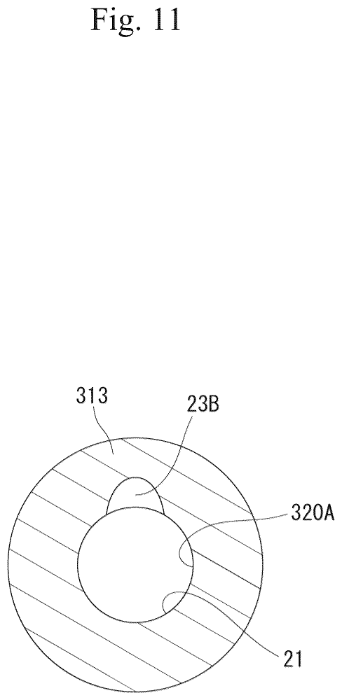

(3) In the above third embodiment, the deformed portion 323 having a recessed shape is formed over the entire circumference, in the circumferential direction, of the inner circumferential surface 320A forming the through-hole 320. However, the deformed portion may be formed only in a part of the inner circumferential surface 320A in the circumferential direction as a modification 23B shown in FIG. 11. That is, as shown in FIG. 11, the deformed portion 23B may have a form recessed radially outward from a part of the inner circumferential surface 20A in the circumferential direction.

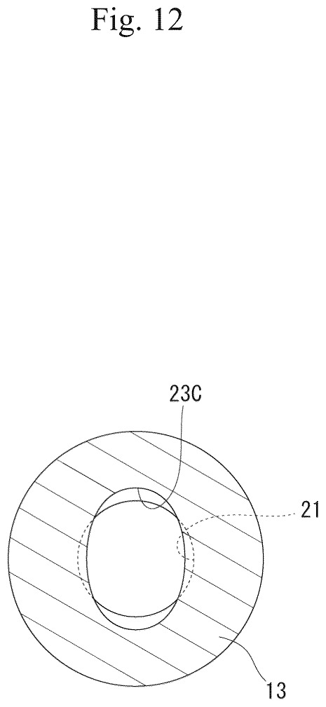

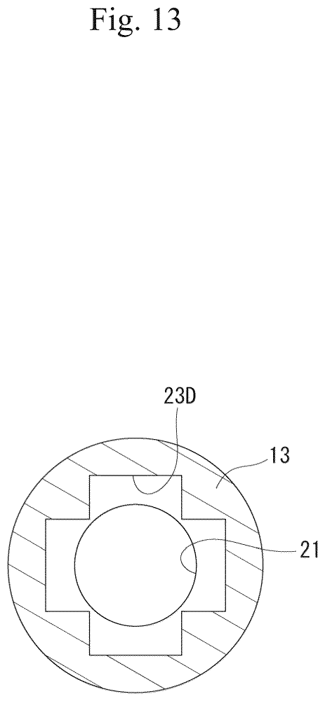

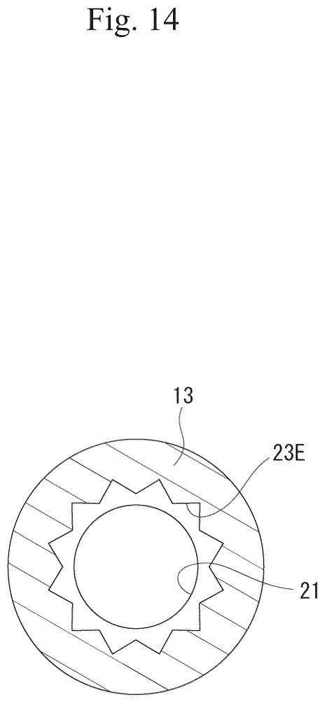

(4) In the above first embodiment, the cross-sectional shape of the deformed portion is a circular shape. However, the cross-sectional shape does not have to be a circular shape. For example, the cross-sectional shape may be an elliptical shape as a deformed portion 23C shown in FIG. 12. In the case where the cross-sectional shape is set to be an elliptical shape as the deformed portion 23C, the waveguide 13 may be compressed in the radial direction such that the waveguide itself has an elliptical shape. Alternatively, the cross-sectional shape may be the shape of a cross as a deformed portion 23D shown in FIG. 13. Alternatively, the cross-sectional shape may be the shape of a star as a deformed portion 23E shown in FIG. 14. In the case where the cross-sectional shape of the deformed portion 23C, 23D, 23E differs from the cross-sectional shape of the first inner circumferential surface 21, as the deformed portion 23C, 23D, 23E shown in FIG. 12 to FIG. 14, the deformed portion 23C, 23D, 23E may be a portion located radially inward of the first inner circumferential surface 21, may be a portion located radially outward of the first inner circumferential surface 21, or may be a portion composed of both of these portions.

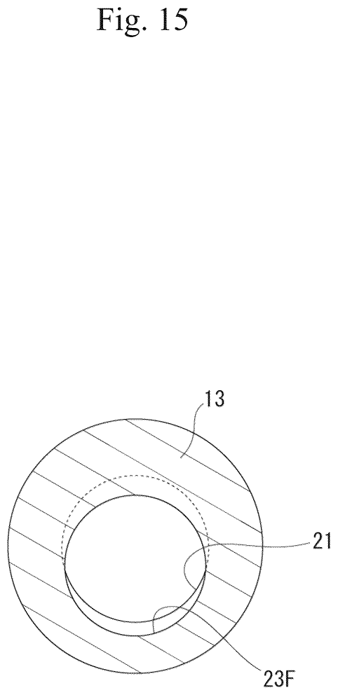

(5) As a deformed portion 23F shown in FIG. 15A, the central axis of the deformed portion may be shifted from the central axis of the first inner circumferential surface 21.

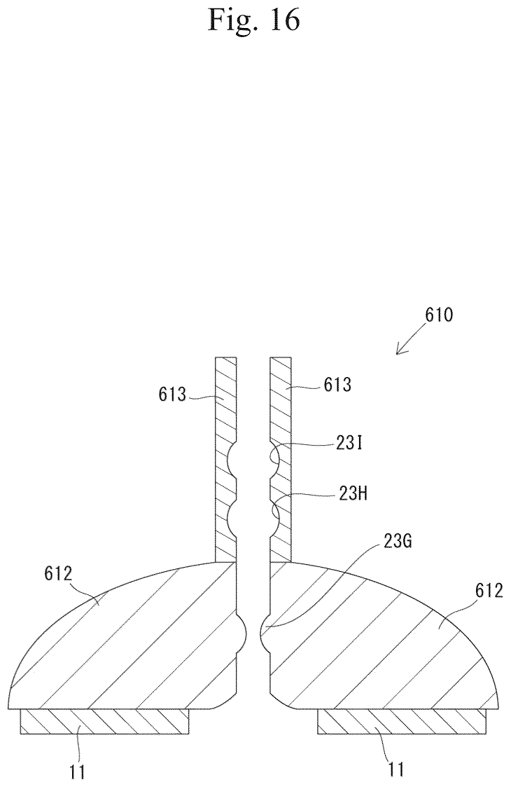

(6) As an ultrasonic wave generation device 610 shown in FIG. 16A, a plurality of deformed portions 23G, 23H, and 23I may be provided at intervals in the front-rear direction. For example, as shown in FIG. 16, the deformed portions 23G, 23H, and 23I may be provided on both an ultrasonic wave converging part 612 side and a waveguide 613 side. Further, as shown in FIG. 16, both the deformed portion 23G having a protruding shape as exemplified in the first embodiment and the second embodiment and the deformed portions 23H and 23I each having a recessed shape as exemplified in the third embodiment, may be provided. Furthermore, although the deformed portions 23G, 23H, and 23I are arranged at intervals in the front-rear direction in FIG. 16, the deformed portions may be continuously arranged without intervals. Still furthermore, although each of the deformed portion 23G having a protruding shape and the deformed portions 23H and 23I each having a recessed shape is formed to have no steps in FIG. 16, the deformed portion may be formed in a stepped shape.

(7) In each of the above embodiments, the first reflection surface 16 and the second reflection surface 17 are paraboloids. Without limitation thereto, both or one of the first reflection surface 16 and the second reflection surface 17 does not have to be a paraboloid in an exact sense, and may have a shape with which the reflection surface can be regarded as an approximate paraboloid. In other words, both or one of the first reflection surface 16 and the second reflection surface 17 only has to be a surface that is curved such that the ultrasonic wave generated from the ultrasonic wave generation source 11 reaches the waveguide 13, 213, 313, 413 via the first reflection surface 16 and the second reflection surface 17. The first reflection surface 16 and the second reflection surface 17 may be composed of a large number of minute flat surfaces.

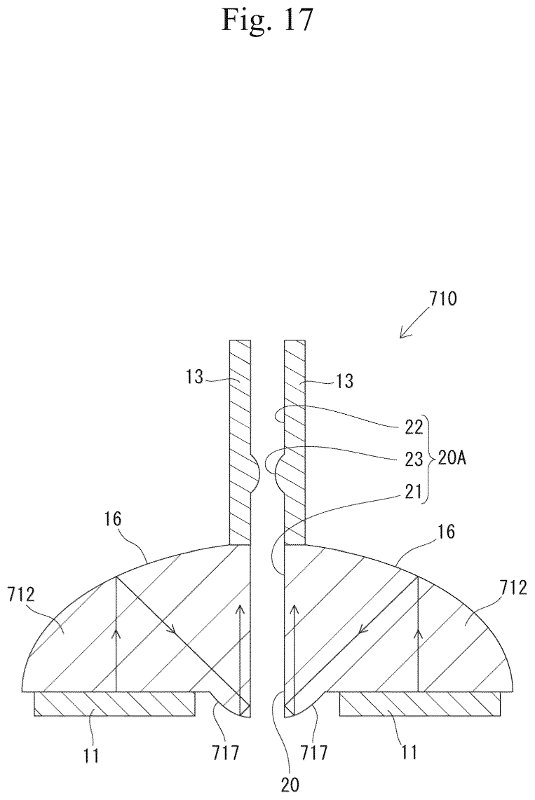

(8) The shape of the second reflection surface 17 is not limited to the shape in the first embodiment shown in FIG. 1. For example, the second reflection surface may have a shape curved so as to protrude rearward as a second reflection surface 717 of an ultrasonic wave converging part 712 in an ultrasonic wave generation device 710 shown in FIG. 17.

(9) In each of the above embodiments, the ultrasonic wave generation source 11 is a piezoelectric element formed of piezoelectric ceramic. Without limitation thereto, another piezoelectric material can be used for the ultrasonic wave generation source 11. The ultrasonic wave generation source 11 may be, for example, a piezoelectric laminated body or the like formed of piezoelectric ceramic.

(10) In each of the above embodiments, the ultrasonic wave generation device 10, 210, 310, 410 has the second inner circumferential surface 22, 222, 422. However, the second inner circumferential surface 22, 222, 422 may not be provided.

The embodiments disclosed herein are merely illustrative in all aspects and should not be recognized as being restrictive. The scope of the present invention is not limited by the embodiments disclosed herein and is intended to encompass the scope defined by the claims and all modifications made within the scope equivalent to the scope of the claims.

### DESCRIPTION OF REFERENCE NUMERALS

10: ultrasonic wave generation device
11: ultrasonic wave generation source
12: ultrasonic wave converging part
13: waveguide
20: through-hole
20A: inner circumferential surface
21: first inner circumferential surface
22: second inner circumferential surface
23: deformed portion
23A: deformed portion
23B: deformed portion
23C: deformed portion
23D: deformed portion
23E: deformed portion
23F: deformed portion
23G: deformed portion
23H: deformed portion
23I: deformed portion
91: liquid
100: power supply device
210: ultrasonic wave generation device
212: ultrasonic wave converging part
213: waveguide
220: through-hole
220A: inner circumferential surface
221: first inner circumferential surface
222: second inner circumferential surface
310: ultrasonic wave generation device
313: waveguide
320: through-hole
320A: inner circumferential surface
323: deformed portion
410: ultrasonic wave generation device
413: waveguide
420: through-hole
420A: inner circumferential surface
421: first inner circumferential surface
422: second inner circumferential surface
423: deformed portion
610: ultrasonic wave generation device
612: ultrasonic wave converging part
613: waveguide
710: ultrasonic wave generation device
712: ultrasonic wave converging part
A: axis

1. An ultrasonic wave generation device comprising:
an ultrasonic wave generation source configured to generate an ultrasonic wave;
an ultrasonic wave converging part configured to converge the ultrasonic wave generated from the ultrasonic wave generation source; and
a waveguide configured to allow transmission therethrough of the ultrasonic wave converged by the ultrasonic wave converging part, wherein
the ultrasonic wave generation source, the ultrasonic wave converging part, and the waveguide are arranged in this order from a rear-end side,
the ultrasonic wave converging part and the waveguide have a through-hole penetrating the ultrasonic wave converging part and the waveguide in a front-rear direction,
an inner circumferential surface forming the through-hole has a first inner circumferential surface and a deformed portion located on a front-end side relative to the first inner circumferential surface,
the first inner circumferential surface has, as a cross-sectional shape taken in the front-rear direction, a shape linearly extending in the front-rear direction, and
the deformed portion is, in a cross section taken in the front-rear direction, at least one of a portion located inward of the first inner circumferential surface and a portion located outward of the first inner circumferential surface, and is formed in a part of or over an entire circumference of the inner circumferential surface in a circumferential direction.

2. The ultrasonic wave generation device according to claim 1, wherein
the through-hole serves as a flow path through which a liquid flows.

3. The ultrasonic wave generation device according to claim 2, wherein
the inner circumferential surface further has a second inner circumferential surface located on the front-end side relative to the deformed portion, and
the second inner circumferential surface has, as a cross-sectional shape taken in the front-rear direction, a shape linearly extending in the front-rear direction.

4. The ultrasonic wave generation device according to claim 2, wherein
the deformed portion is provided in a portion, of the through-hole, that penetrates the waveguide.

5. The ultrasonic wave generation device according to claim 2, wherein
the deformed portion is provided in a portion, of the through-hole, that penetrates the ultrasonic wave converging part.

6. An ultrasonic wave generation system comprising:
the ultrasonic wave generation device according to claim 1; and
a power supply device configured to output an electric signal to the ultrasonic wave generation device.
